(19) United States
(12) Patent Application Publication
(10) Pub. No.: US 2004/0153662 A1
(43) Pub. Date: Aug. 5, 2004

(54) Expert system for uncovering counter-indications in case of limited access to patient data

(76) Inventors: Eva Rumpel, Erlangen (DE); Kai-Uwe Schmidt, Erlangen (DE); Klaus Abraham-Fuchs, Erlangen (DE); Johannes Bieger, Munchen (DE); Daniel Tietze, Spardorf (DE)

Correspondence Address: HARNESS, DICKEY & PIERCE, P.L.C., P.O.BOX 8910, RESTON, VA, 20195, US

(21) Appl. No.: 10/482,132

(22) PCT Filed: Jun. 21, 2002
(86) PCT No.: PCT/DE02/02284

(30) Foreign Application Priority Data
Jun. 26, 2001 (DE) 101 30 614.8

(51) Int. Cl. G06F 11/30

(52) U.S. Cl. 713/200

(57) ABSTRACT

The invention relates to a device for uncovering counter-indications in case of limited access to patient data. According to the invention, an expert system, which has access to patient data in different patient files and/or with different doctors or clinics, checks off an actual treatment plan for counter-indications of old patient data and without the need to disclose said patient data informs the patient and/or the doctor concerned of the presence of the counter-indications.

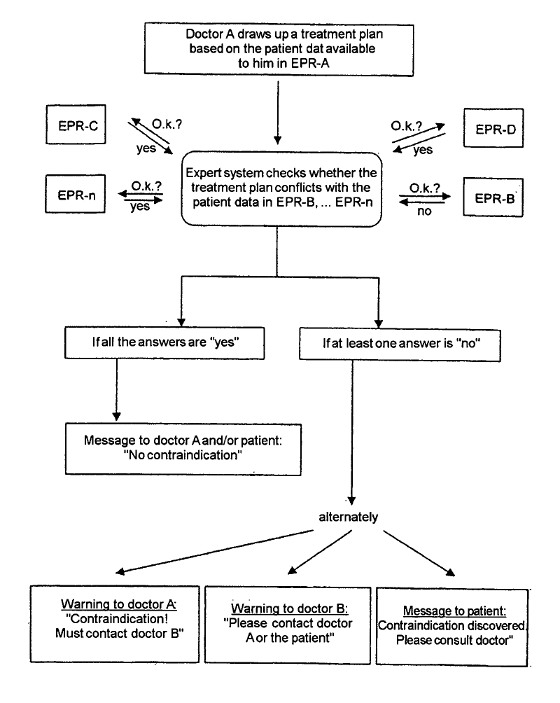

The quality of any medical decision, whether it concerns a diagnosis, a proposal for therapy, or a treatment plan, depends essentially on the completeness of the relevant data. Computer-based solutions can of course provide assistance when it comes to making a diagnosis or a therapy decision in a complex data situation. The networking of spatially separate databases also permits inclusion of patient data which have been recorded by other institutions. However, there are legal and psychological limits to IT solutions. This is because medical confidentiality also applies to communication between doctors, so that whenever there is no direct treatment relationship between them, the express written consent of the patient must be obtained when contacting another doctor or another hospital. However, a common difficulty with this is when a patient insists that certain data which he feels to be particularly sensitive, for example data concerning psychiatric treatment or venereal disease, must remain only with the psychiatrist or with the dermatologist or family doctor concerned and must not be made accessible to other doctors treating him. For this reason, of course, it cannot be assumed that all information concerning a patient when drawing up a therapy or treatment plan are actually available to the doctor who is drawing up this plan. There is therefore still a risk that possible contraindications, for example allergies or intolerance to drugs, will remain undetected.

In the past, of course, it has always been sought to record all relevant data anew each time by questioning and examining the patient or, in cases of patient referrals, to obtain such data from the previous doctor in the form of a doctor's letter. However, the extent to which contraindications are uncovered in this way largely depends on the willingness and ability of the patient to cooperate, since the doctor or the hospital drawing up an acute treatment plan, for example, will not know the other doctors or clinics, nor will they know of any previous or concurrent diseases suffered by the patient.

The aforementioned difficulties also arise in a method for creating and providing access to a specific patient health index, as is described in WO 95/26006 A1. The specific health index is in the final analysis nothing more than the centrally stored or decentralized patient records mentioned in the introduction, and here once again there is the disadvantage that access authorization to these patient records is necessary, and the patient will not necessarily grant such authorization, at least not to certain areas of these patient records. Accordingly, a treating physician cannot check a treatment plan he has drawn up against all the relevant data from the personal health records, with the added consideration that in many cases such a check will fail because of the multiplicity of the data stored, it being impossible for the treating physician to examine and evaluate these data in their entirety.

The system described in U.S. Pat. No. 6,188,988 B1 is also unable to solve the above-described difficulties since this system too assumes that the whole of the existing patient record with all its medical data must be disclosed so that the subsequent doctor, possibly assisted by an expert system, may draw conclusions regarding an actual treatment plan. This complete disclosure of the patient records to each new treating physician is not feasible and cannot be expected to be so in the future either.

Finally, U.S. Pat. No. 6,031,910 describes the way in which data on a patient card can be encrypted. Such data encryption is the subject of all storage systems and systems for central or decentralized management of patient records. This kind of access restriction is of course also indispensable in the context of the present application, but it cannot by itself solve the problem of limited access to patient records because of the refusal by the patient.

The object of the invention is therefore to create a device for uncovering contraindications in cases of limited access to patient data, which device is able to record all the relevant patient data, largely independently of the willingness and ability of the patient to cooperate, and without undesired transmission of sensitive data to other doctors.

To achieve this object, such a device according to the invention is characterized by an expert system which has access to patient data in different patient records and/or with different doctors or clinics, checks an actual treatment plan for contraindications from earlier patient data, and, without disclosing the patient data, informs the patient and/or the doctors concerned of the presence of possible contraindications.

In this context, the term “expert system” is understood as the mapping of the specialist knowledge of a medical expert into logical rules which can be implemented as software codes. The “expert system” designed as software allocates to the variables of the logical rules data from a data bank (e.g. the electronic patient records) and, on each inquiry, checks whether the rules in the present case are complied with or whether, by contrast, they are contravened. One example of such a rule would be “Up to the 5th month of pregnancy, medicaments containing active substance X must not be administered in a dose of more than Y mg per day, unless the diagnosis is A and the patient has an intolerance to medicaments of class B”. The associated variables X and Y of the rule are taken from the treatment plan, while the variables A, B and the actual month of pregnancy are taken from the EPR.

The approach constituting the solution according to the invention can be followed in particular when all relevant patient data are stored in electronic form, either on a central server, or decentralized with doctors and clinics connected to one another via a data network. Since the patient has explicitly refused third parties the right to access his data and to transmit these data, the only possibility remaining is to ask him to permit use of the data in anonymized form. If the patient allows the doctor treating him this kind of “anonymized” access to data recorded by other doctors, these data are then available (if only for a short time) for purely machine-based evaluation. The checking of the data, or more precisely the checking of a treatment plan or proposed diagnosis against these data, is effected by an expert system which does not disclose the confidential information to other parties, but only the result of the check. If the expert system finds no conflict with a proposed diagnosis or no sign of a contraindication to a treatment proposal, it transmits the message “Everything in order” to the doctor or hospital making the inquiry. If the expert system discovers a fact which conflicts with the proposed diagnosis or proposed treatment, the patient himself decides who is to be notified of this. In this respect, a number of alternatives are possible.

The patient receives information to the effect that the data segment pertaining to doctor B contains information conflicting with the treatment plan of doctor A, and he can now decide who to turn to for advice concerning this information.

The doctor presently treating the patient, i.e. doctor A, receives the notification concerning the presence of a contraindication together with the name and address of doctor B who has access to the relevant patient information.

Doctor B, who has access to the patient information conflicting with the proposed treatment or proposed diagnosis, receives the name and address of doctor A who has drawn up the treatment plan, together with a request to contact doctor A. Of course, these above alternatives can also be combined in any desired way.

The data to be transmitted as the result of the “anonymous” check by the expert system contain as a minimum the name and address of a contact. The message to the patient himself or to doctor B should also contain one or more keywords pointing to the background of the problem, for example “depression”, “pregnancy” or “high blood pressure”.

The advantage of the device according to the invention is that the wish expressed by the patient for confidentiality, even concerning data relevant to his treatment, can be observed without in so doing compromising the result of the medical measures. A further advantage is to be seen in the fact that the specific output of a small amount of information, but important information, can be controlled by the patient and configured in almost any way he wants. This anonymized checking of a proposed treatment or proposed diagnosis for conflicts with the existing data a situation by an expert system is particularly suitable for processes in which contraindications are rarely present but in which their occurrence would have serious consequences.

Further advantages, features and details of the invention will become evident from the following description of an illustrative embodiment in which reference is made to the flow chart reproduced in the drawing.

This flow chart shows how a treatment plan drawn up by doctor A, on the basis of the patient data available to him in a patient record EPR-A, is fed to an expert system which has anonymized access to further electronic patient records EPR-B, EPR-C, EPR-D, . . . EPR-n. This expert system checks whether the treatment plan conflicts with the patient data in these different electronic patient records EPR-B, . . . EPR-n. To do this, it simply asks whether, on the basis of the existing data situation, the treatment plan is in order, which in practice naturally means that it correspondingly evaluates the data in the patient record.

If all the answers are “yes”, a message is simply sent to doctor A and/or to the patient stating that no contraindications have been found. The treatment plan can therefore be started.

If at least one of the responses is “no”, that is to say if one of the patient records outputs a report which, in the assessment of the expert system, conflicts with the treatment plan, warning messages are sent alternately or, if appropriate, simultaneously to the doctor presently treating the patient, i.e. doctor A, and to doctor B who has access to the patient data conflicting with the treatment plan, or, and this practically in every case, to the patient. These messages can of course be sent automatically by the server without human intervention, so that no third person receives any information via the information transmitted to the different doctors or to the patient.

1. A device for uncovering contraindications in cases of limited access to patient data, characterized by an expert system which has access to patient data in different patient records and/or with different doctors or clinics, checks an actual treatment plan for contraindications from earlier patient data, and, without disclosing the patient data, informs the patient and/or the doctors concerned of the presence of contraindications.

2. The device as claimed in claim 1, characterized in that the expert system is connected to one or more electronic patient records in which the data, which may optionally be encoded, are in each case available only to certain authorized parties.

3. The device as claimed in claim 1 or 2, characterized in that, on discovering a contraindication, the expert system first informs the patient and makes proposals about notifying individual doctors.

4. The device as claimed in one of claims 1 through 3, characterized in that, on discovering a contraindication, the expert system informs the doctor who is drawing up the treatment plan, and making the inquiry, of the presence of a contraindication, but without giving details.

5. The device as claimed in one of claims 1 through 4, characterized in that, on discovering a contraindication, the expert system informs the doctor with authorized access to the patient data which conflict with the proposed treatment and asks him to contact the doctor who is presently providing treatment.
